(19) United States
(12) Patent Application Publication
(10) Pub. No.: US 2019/0335565 A1
(43) Pub. Date: Oct. 31, 2019

(54) INTELLIGENT ILLUMINATION SYSTEM

(71) Applicants: Austin Lai, Taichung City (TW); Chi-I Lai, Taichung City (TW); Jhong-Kai Jiang, Taichung City (TW)

(72) Inventors: Austin Lai, Taichung City (TW); Chi-I Lai, Taichung City (TW); Jhong-Kai Jiang, Taichung City (TW)

(73) Assignee: AVERTRONICS INC., Taichung City (TW)

(21) Appl. No.: 16/378,282

(22) Filed: Apr. 8, 2019

(30) Foreign Application Priority Data
Apr. 25, 2018 (TW) 107114036

(51) Int. Cl. H05B 37/02; E06B 9/68

(52) U.S. Cl. CPC H05B 37/0218; E06B 2009/6827; E06B 9/68

(57) ABSTRACT

An intelligent illumination system may comprise a three-dimensional space evenly divided into four main areas, and each two adjacent main areas has an overlapped area to form four adjacent areas. Four ambient light sensors are respectively installed in the four main areas, and four main area illumination values respectively corresponding to the four main areas are measured by the ambient light sensors from a designed oblique angle. A controller is electrically connected to the ambient light sensors to read the main area illumination values and to calculate each of adjacent area illumination values of adjacent areas, wherein the sum of the main area illumination values of each two adjacent main areas is configured to be averaged, then multiples by a direct illumination influence ratio, and adds an indirect illumination influence ratio so as to obtain each of the adjacent area illumination values of the adjacent areas.

### FIELD OF THE INVENTION

The present invention relates to an illumination system and more particularly to a low-cost and high-sensing intelligent illumination system.

### BACKGROUND OF THE INVENTION

Generally, human's vision is affected by environmental illumination. However, it not means that the higher illumination is absolutely better for eyesight, and it will damage the muscles of eyes and lead to myopia when people use eyes under the environment where the illumination is too strong or too weak. Therefore, in order to achieve the vision health care, it is important to have appropriate illumination requests in places such as classroom, conference room, and office. For example. CNS's illumination standard for an office or a classroom is 500 lux, and a user could know whether the illumination is appropriate for an environment through measuring. There are two common measuring methods, which are (i) average illumination measurement and (ii) individual illumination measurement. For average illumination measurement, a plurality of sensors are placed in a space, and each of the sensors is configured to detect multiple light sources within a measurable range. The obtained values from the sensors are averaged to get the average illumination value of the space, and thereafter the light sources are uniformly adjusted according to the average illumination value. However, the accuracy of average illumination measurement is low and the uniform adjustment for light sources may easily cause that some areas are too bright or too dark. On the other hand, for individual illumination measurement, each of sensors is installed at a position vertically downward to a light source so as to individually measure the illumination of the light source. Although the above measurement has high accuracy, the large number of sensors will greatly increase the cost of its construction, and the program operation of control and sensing are also relatively complex so as to make more errors. Also, the installation of the sensors is unaesthetic. Therefore, there remains a need for a new and improved design for an intelligent illumination system to overcome the problems presented above.

### SUMMARY OF THE INVENTION

The present invention provides an intelligent illumination system which comprises a three-dimensional space evenly divided into four main areas, and each two adjacent main areas has an overlapped area to form four adjacent areas. Four ambient light sensors are respectively installed in the four main areas, and four main area illumination values respectively corresponding to the four main areas are measured by the ambient light sensors from a designed oblique angle. A controller is electrically connected to the ambient light sensors to read the main area illumination values and to calculate each of adjacent area illumination values of adjacent areas, wherein the sum of the main area illumination values of each two adjacent main areas is configured to be averaged, then multiples by a direct illumination influence ratio, and adds an indirect illumination influence ratio so as to obtain each of the adjacent area illumination values of the adjacent areas.

In one embodiment, a central area is formed at a center position of the main areas, and the adjacent area illumination values are configured to be averaged to obtain a central area illumination value.

In another embodiment, a floor plane of the three-dimensional space is a square which is evenly divided into the four square-shaped main areas, and the four ambient light sensors are respectively positioned at four corners of the three-dimensional space in the main areas.

In still another embodiment, the square-shaped floor plane of the three-dimensional space is evenly divided into the four triangle-shaped main areas, and the four ambient light sensors are respectively positioned in the main areas, and each of the four ambient light sensors is located at a position close to a middle of an edge of the three-dimensional space.

In a further embodiment, the direct illumination influence ratio is an attenuation ratio caused by the light range which is based on an average spacing among the light sources and a vertical height of light source.

In still a further embodiment, the average spacing and the vertical height of light source form a hypotenuse distance as a triangle, and the direct illumination influence ratio is the reciprocal of the value of the hypotenuse distance, and the hypotenuse distance is obtained through the right-angled triangle definition.

In a particular embodiment, the indirect illumination influence ratio is an average value of illumination accumulations from mutually reflecting between a ceiling and the floor in the three-dimensional space.

In another particular embodiment, for obtaining the indirect illumination influence ratio, the sum of the main area illumination values is averaged, and multiples the reflected illumination which forms from the ceiling and the floor reflecting lights from the light sources, and the reflected illumination is calculated through the cumulative method to obtain corresponding reflected illumination values of materials in different environments, and each of the corresponding reflected illumination values is averaged to obtain that the ceiling has the fixed value of 0.65 and the floor has the fixed value of 0.15.

In an advantageous embodiment, the controller is electrically connected to a projector, a screen, and at least an electric curtain, and the controller is adapted to automatically control the shading positions of the electric curtain based on the main area illumination values, the adjacent area illumination values, and the central area illumination value; when the projector and the screen are used, the controller is configured to automatically dim or turn off one or more of the light sources adjacent to the screen and control the electric curtain adjacent to the screen to perform full-shading synchronously.

In a preferred embodiment, the controller is electrically connected to a temperature sensor, a humidity sensor, and an optical sensor which are configured to respectively obtain the temperature of the three-dimensional space, the humidity of the three-dimensional space, and the outdoor sunlight illumination and direction, and the controller is electrically connected to at least an electric curtain and is adapted to automatically adjust the intensity of the light sources and the shading position of the electric curtain according to the environmental conditions.

Comparing with conventional illumination system, the present invention is advantageous because: (i) the intelligent illumination system is adapted to use the minimum number of ambient light sensors to efficiently adjust the light sources in the three-dimensional space; and (ii) the calculation through the controller is adapted to compensate the error of direct sensing and to obtain the adjacent area illumination values and the central area illumination value precisely.

### BRIEF DESCRIPTION OF THE DRAWINGS

FIG. 1 is a schematic view illustrating the spatial area distribution of a three-dimensional space of an intelligent illumination system of the present invention.

FIG. 2 is a schematic view illustrating the arrangement of four main areas, four adjacent areas, and four ambient light sensors of the intelligent illumination system of the present invention.

FIG. 3 is a schematic view illustrating the arrangement of the adjacent areas and a central area of the intelligent illumination system of the present invention.

FIG. 4 is a schematic view of relative positions of values of a direct illumination influence ratio of the intelligent illumination system of the present invention.

FIG. 5 is a diagram of a control interface of the intelligent illumination system of the present invention.

FIG. 6 is a circuit diagram of the ambient light sensor of the intelligent illumination system of the present invention.

FIG. 7 is a schematic view of another embodiment illustrating the spatial area distribution of the three-dimensional space of the intelligent illumination system of the present invention.

FIG. 8 is a schematic view of a third embodiment illustrating the spatial area distribution of the three-dimensional space of the intelligent illumination system of the present invention.

FIG. 9 is a three-dimensional view illustrating the intelligent illumination system of the present invention is applied to the three-dimensional space.

FIG. 10 is a diagram of the control interface of another embodiment of the intelligent illumination system of the present invention.

FIG. 11 is a diagram of the control interface of a further embodiment of the intelligent illumination system of the present invention.

FIG. 12 is a block diagram of the assembly of the intelligent illumination system of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

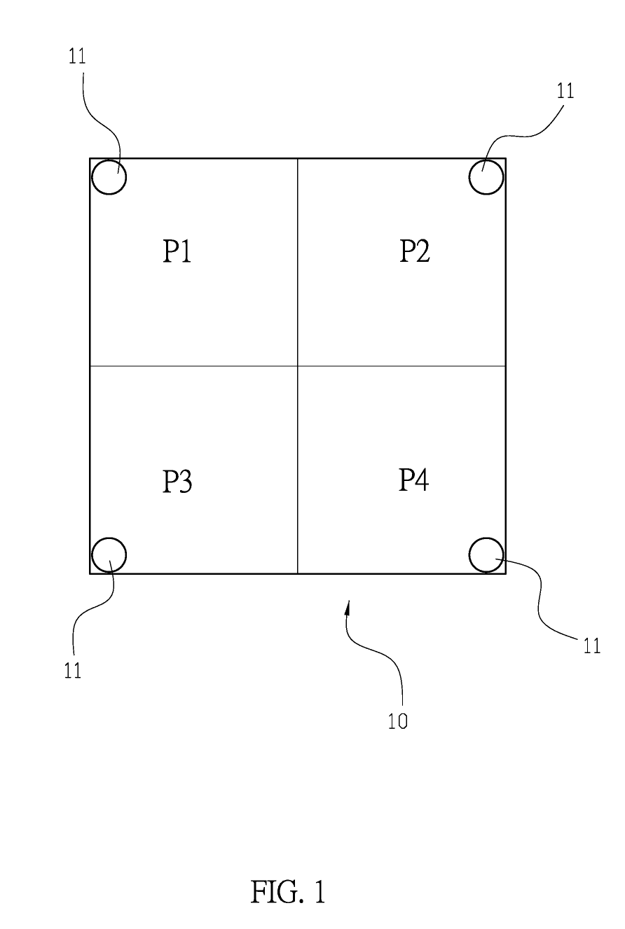

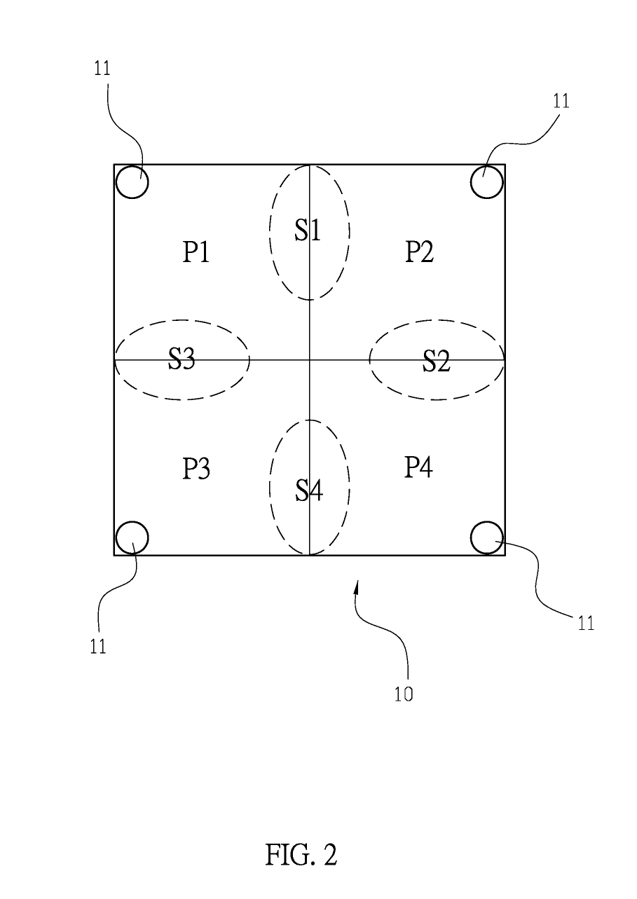

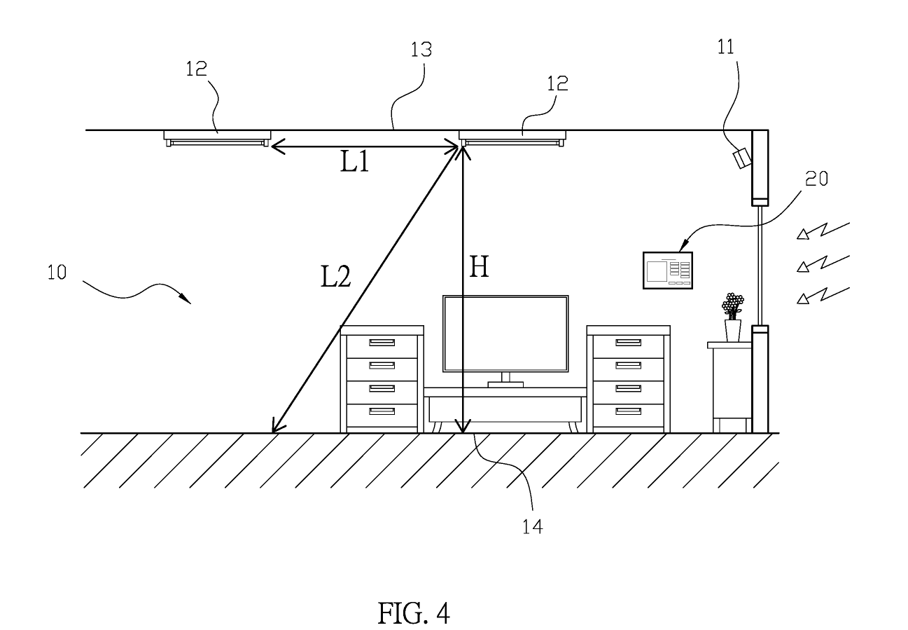

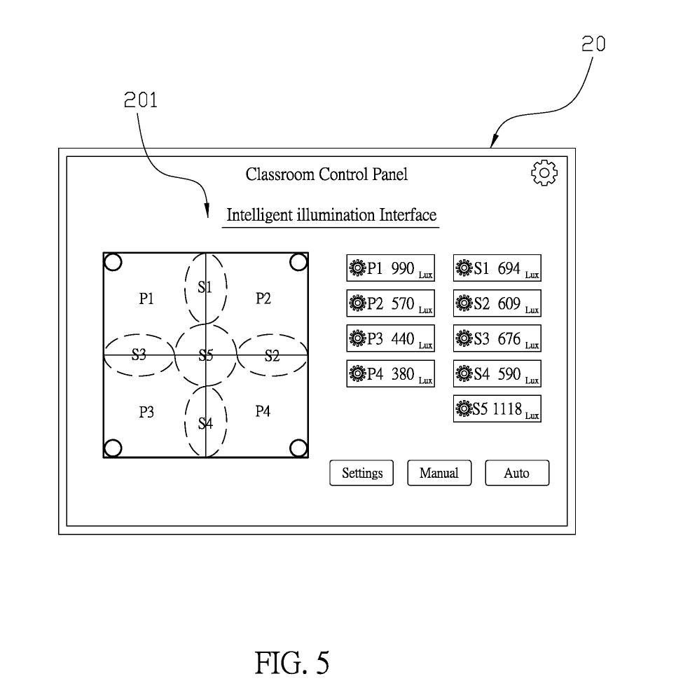

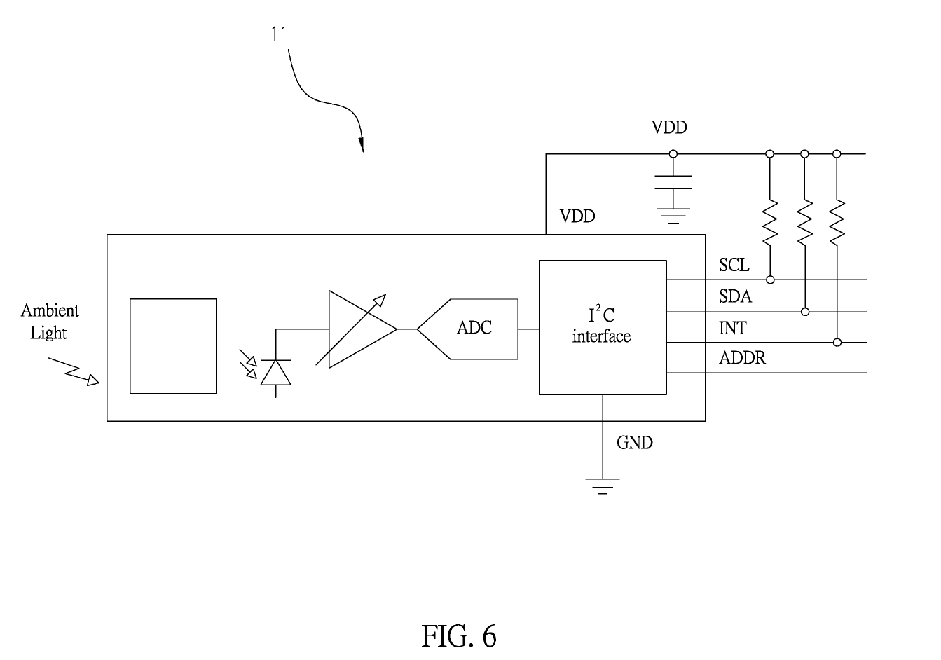

Referring to FIGS. 1 to 5, the present invention provides an intelligent illumination system which comprises a three-dimensional space (10) which is evenly divided into four main areas (P1, P2, P3, P4), and each two adjacent main areas has an overlapped area to form four adjacent areas (S1, S2, S3, S4). Four ambient light sensors (11) are respectively installed in the four main areas (P1, P2, P3, P4), and a circuit diagram shown in FIG. 6 is configured to prove that the ambient light sensors (11) are implemented but it does not limit what kind of photosensitive circuit can achieve the propose of illumination sensing. Furthermore, four main area illumination values (p1, p2, p3, p4) respectively corresponding to the main areas (P1, P2, P3, P4) are measured by the ambient light sensors (11) from a designed oblique angle, wherein each of the main area illumination values (p1, p2, p3, p4) is the average illumination value within the sensing range of the ambient light sensor (11). The sensing range of the ambient light sensor (11) is configured to be set according to different models of the ambient light sensor (11) and different space sizes of the three-dimensional space (10). Thus, the sensing range is adapted to be set equal to or close to the main areas (P1, P2, P3, P4), and similarly, the designed oblique angle is configured to be adjusted depending on the space size of the three-dimensional space (10) to a degree angle between 45 degrees and 75 degrees relative to the vertical direction. A controller (20) is electrically connected to the ambient light sensors (11) to read the main area illumination values (p1, p2, p3, p4) and to calculate each of adjacent area illumination values (s1, s2, s3, s4) of adjacent areas (S1, S2, S3, S4). The formulas of the calculations are shown as below:

s1=((p1+p2)/2)M+G

s2=((p2+p4)/2)M+G

s3=((p1+p3)/2)M+G

s4=((p3+p4)/2)M+G

Wherein the sum of the main area illumination values of each two adjacent main areas is configured to be averaged, then multiples by a direct illumination influence ratio (M), and adds an indirect illumination influence ratio (G) so as to obtain each of the adjacent area illumination values (s1, s2, s3, s4) of the adjacent areas (S1, S2, S3, S4).

As described above, the main area illumination values (p1, p2, p3, p4) and the adjacent area illumination values (s1, s2, s3, s4) are obtained. Moreover, a central area (S5) is formed at a center position of the main areas (P1, P2, P3, P4), and the adjacent area illumination values (s1, s2, s3, s4) are configured to be averaged to obtain a central area illumination value (s5). The formula of the calculation is shown as below:

s5=(s1+s2+s3+s4)/4

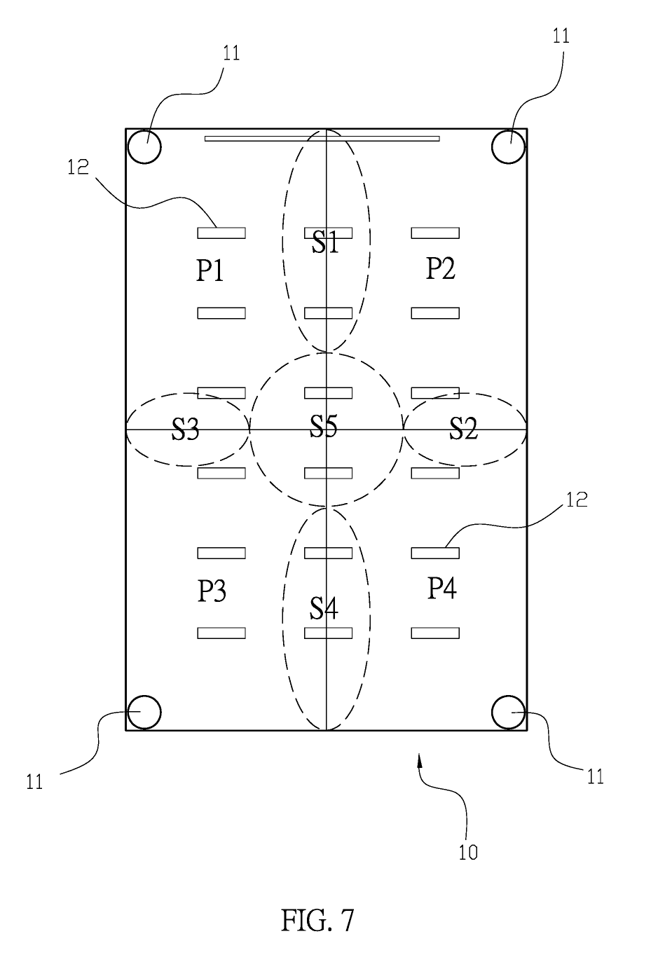

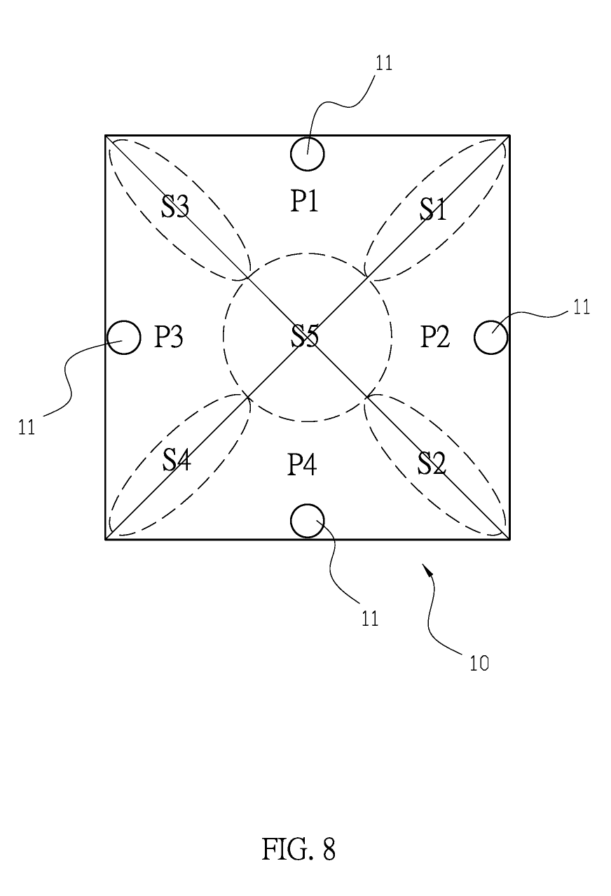

Through the ambient light sensors (11), the direct illumination influence ratio (M), and the indirect illumination influence ratio (G), the main area illumination values (p1, p2, p3, p4), the adjacent area illumination values (s1, s2, s3, s4), and the central area illumination value (s5) of the three-dimensional space (10) are calculated and obtained, which uses the minimum number of ambient light sensors (11) to efficiently adjust the light sources (12) in the three-dimensional space (10). The number of the light sources (12) in the three-dimensional space (10) is more than four, and a floor plane of the three-dimensional space (10) is a square which is evenly divided into the main areas (P1, P2, P3, P4) in square shapes. The four ambient light sensors (11) are respectively positioned at four corners of the three-dimensional space (10) in the main areas (P1, P2, P3, P4), which are four diagonal positions relative to the central area (S5). In one embodiment, referring to FIG. 7, the three-dimensional space (10) is a rectangle space, and a plurality of light sources (12) are arranged in the three-dimensional space (10) with unequal spacing. In another embodiment, referring to FIG. 8, the floor plane of the three-dimensional space (10) which is square is evenly divided into the main areas (P1, P2, P3, P4) in triangle shapes, and the four ambient light sensors (11) are respectively positioned in the main areas (P1, P2, P3, P4), wherein each of the four ambient light sensors (11) is located at a position close to a middle of an edge of the three-dimensional space (10).

More specifically, referring to FIGS. 1 to 5, the direct illumination influence ratio (M) is an attenuation ratio caused by the light range which is based on an average spacing (L) among the light sources (12) and a vertical height of light source (H). When the distance between the light sources (12) and a floor (14) of the three-dimensional space (10) is fixed, the direct illumination is double when the intensity of the light sources (12) is doubled. On the other hand, the direct illumination is inversely proportional to the distance between the light sources (12) and the floor (14), and when the intensity of the light sources (12) is fixed, the illumination area is expanded to four times when the distance between the light sources (12) and the floor (14) is doubled. Also, the direct illumination becomes a quarter of what it was before, where the principle is called as the Law of Inverse Squares which can calculate the attenuation ratio caused by the light range. In the formula of the direct illumination influence ratio (M), the average spacing (L1) and the vertical height of light source (H) form a hypotenuse distance (L2) as a triangle, and the direct illumination influence ratio (M) is the reciprocal of the value of the hypotenuse distance (L2). Also, the hypotenuse distance (L2) is obtained through the right-angled triangle definition, wherein the formulas are shown as below:

M=1/L2

L2=\sqrt{L1²+H²}

The indirect illumination influence ratio (G) is an average value of illumination accumulations from mutually reflecting between a ceiling and the floor (14) in the three-dimensional space (10). The sum of the main area illumination values (p1, p2, p3, p4) is averaged, and multiples the reflected illumination which forms from the ceiling (13) and the floor (14) reflecting lights from the light sources (12). The indirect illumination of the light sources includes the light reflected from the ceiling (13), the floor (14) and walls of the three-dimensional space (10), and the lights mutually reflected from any angles. Also, the lights from the light sources (12) are configured to be partially absorbed by materials such as the ceiling (13), the walls, the floor (14), and furniture or to emit out of windows of the three-dimensional space (10). Therefore, it is necessary to have the indirect illumination influence ratio (G) to correct the illumination value. However, the main influences of the indirect illumination to the illumination value are the reflection from the ceiling (13) and the floor (14), and the other factors affecting to the illumination value are relatively small and negligible. Therefore, the reflected illumination is calculated by taking the average reflectivity of general indoor space materials (refer to CNS standard illuminance design), which is the fixed value of 0.65 for the ceiling and 0.15 for the floor, so that the fixed value of the sum (0.8) is applied to different environments, wherein the formula is shown as below:

G=((p1+p2+p3+p4)/4)*0.8

The direct illumination influence ratio (M) and the indirect illumination influence ratio (G) are strain values derived from relevant theories and practical measurements. With the values of the average spacing (L1) among different light sources (12) and the vertical height of light source (H), and through dividing the three-dimensional space (10) into four equal parts, the four ambient light sensors (11) are adapted to measure and obtain the main area illumination values (p1, p2, p3, p4). Furthermore, since the adjacent areas (S1, S2, S3, S4) and the central area (S5) are located far from the ambient light sensors (11), which greatly reduces the accuracy of measurement. In addition, since the central area (S5) has the most overlapped lights from the light sources, the relative strong of actual illumination cannot be directly detected by the ambient light sensors (11). Therefore, the formula calculation through the controller (20) is adapted to compensate the error of direct sensing and to obtain the adjacent area illumination values (s1, s2, s3, s4) and the central area illumination value (s5) precisely. As a result, the ambient light sensors (11) is configured to accurately obtain the illumination values of the nine areas in the three-dimensional space (10), and the controller (20) is adapted to adjust each of intensities of the light sources (12) so as to effectively control the average illumination in the three-dimensional space (10).

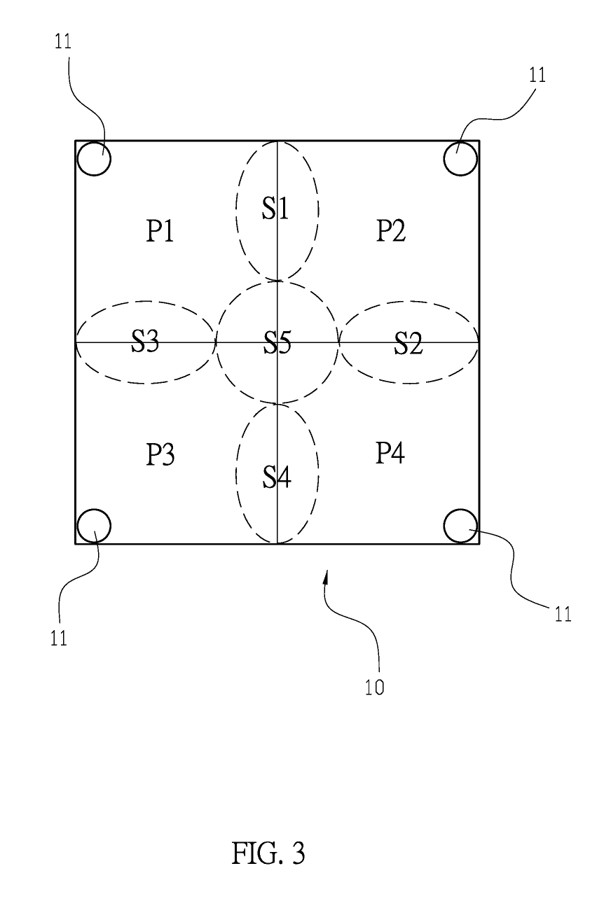

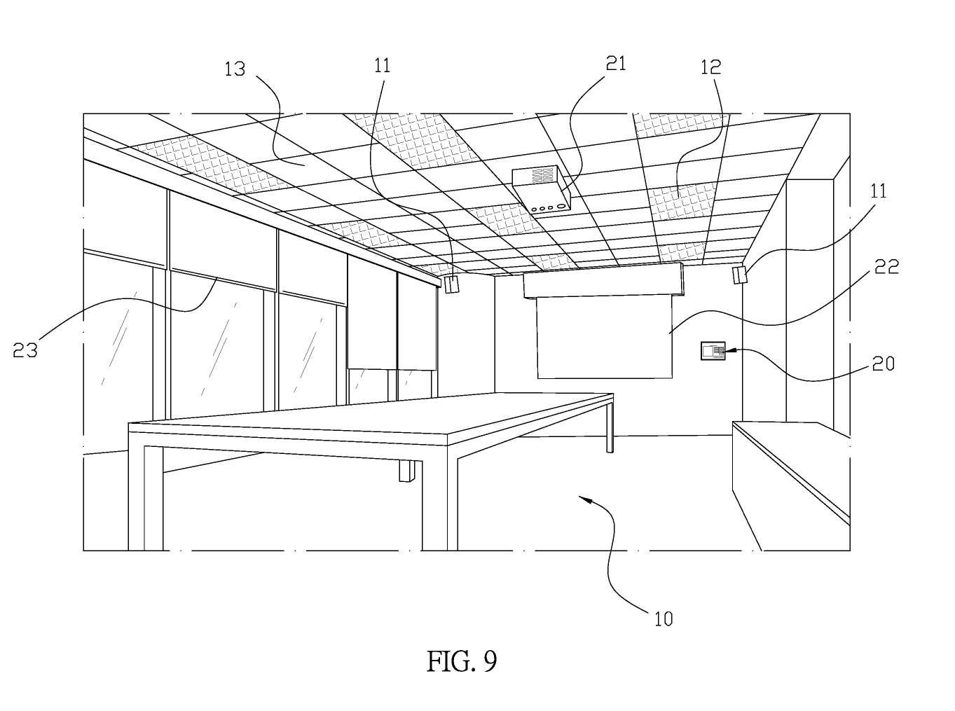

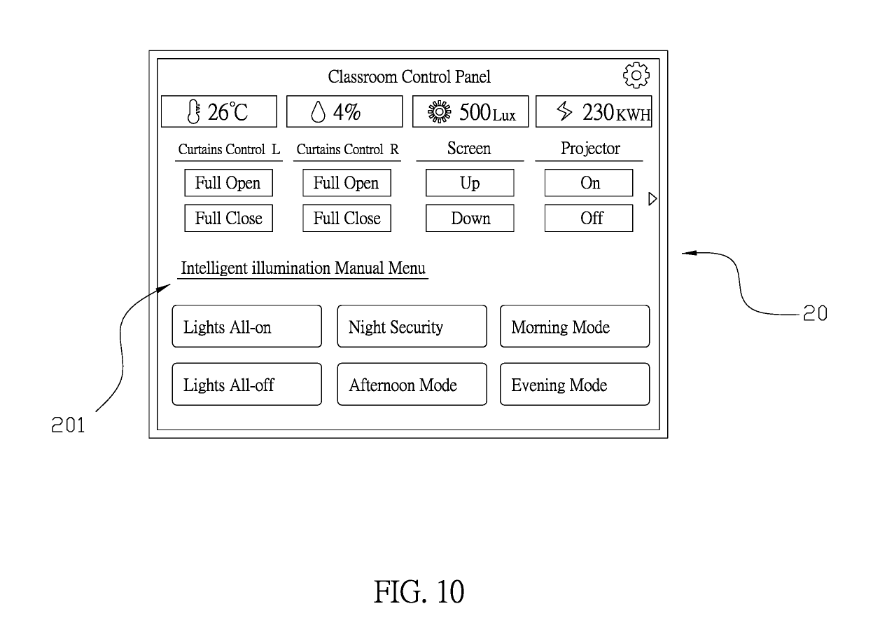

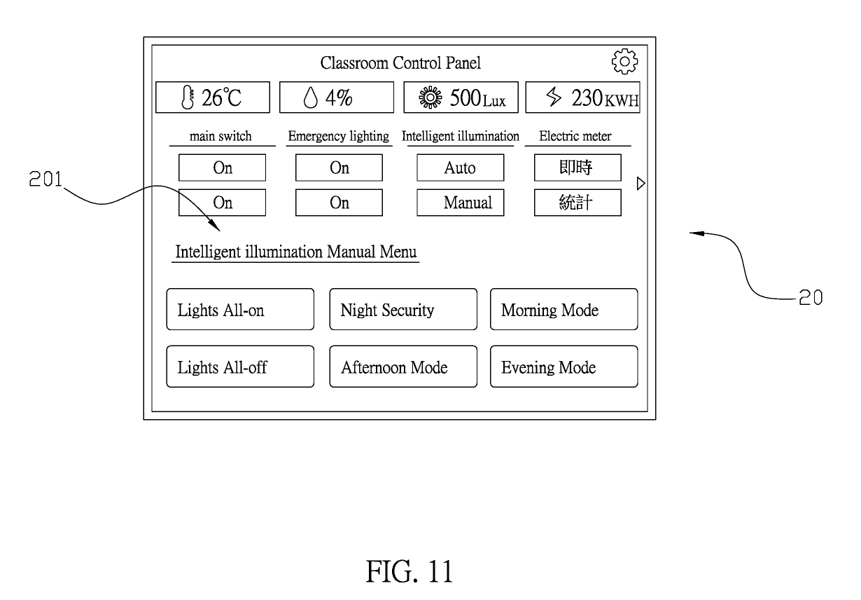

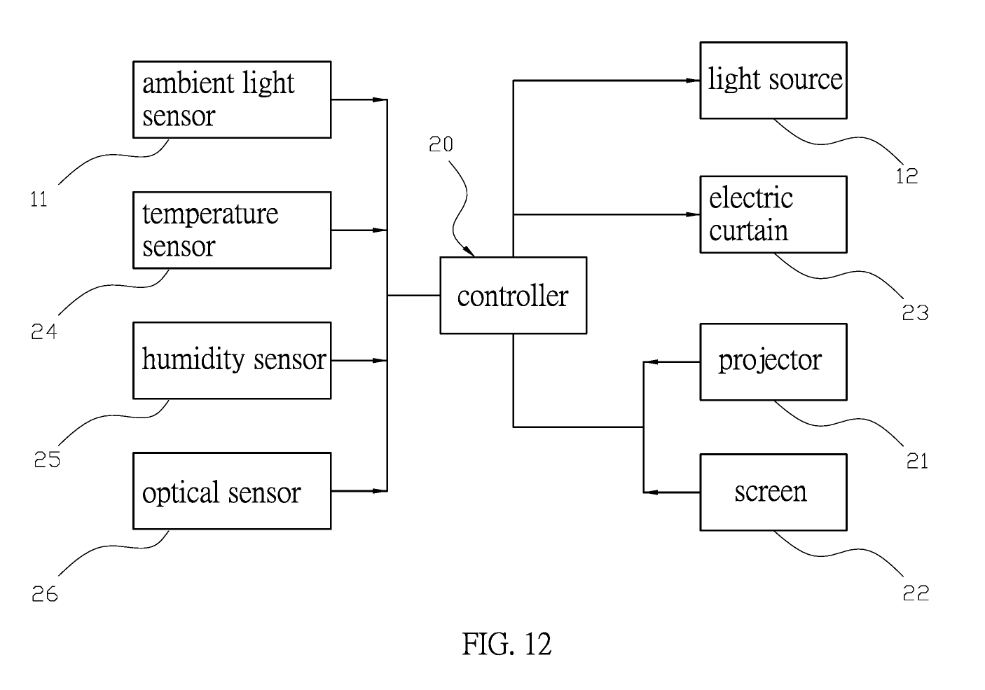

In actual application, referring to FIGS. 3, 9, and 10, the controller (20), which is electrically connected to a projector (21), a screen (22), and at least an electric curtain (23), comprises a control interface (201), and the control interface (201) has a plurality of buttons to perform various functions such as controlling of curtain, screen and projector, manually and automatically controlling lighting patterns, displaying various sensing values including temperature, humidity, intensity of illumination, and power consumption. Thus, the intelligent illumination system allows a user to set different lighting modes and brightness and also automatically perform light supplement and subtraction so as to meet the lighting standard for human eyes. The controller (20) is adapted to automatically control the shading positions of the electric curtain (23) based on the main area illumination values (p1, p2, p3, p4), the adjacent area illumination values (s1, s2, s3, s4) and the central area illumination value (s5). For example, in case that the sunshine comes from the main areas of P2 and P4 into the three-dimensional space (10), the main area illumination values of p2 and p4 are configured to relative higher than others. At this time, the controller (20) is adapted to automatically move the electric curtain (23) down so as to achieve the purpose of light reduction. Also, when the shading of the electric curtain (23) leads to insufficient illumination, the controller (20) is configured to control the light sources (12) to perform the light supplement. Moreover, when the projector (21) and the screen (22) are used, the controller (20) is configured to automatically dim or turn off one or more of the light sources (12) adjacent to the screen (22) and control the electric curtain (23) adjacent to the screen (22) to perform full-shading synchronously, so as to achieve the best projection effect. Similarly, when the intelligent illumination system of the present invention is applied to a classroom or conference room, it can set a specific area such as whiteboard, blackboard, and podium as a focus area to have additional supplement light. Referring to FIGS. 11 and 12, the controller (20) is electrically connected to a temperature sensor (24), a humidity sensor (25), and an optical sensor (26) which are configured to respectively obtain the temperature of the three-dimensional space (10), the humidity of the three-dimensional space (10), and the outdoor sunlight illumination and direction, and the controller (20) is adapted to automatically adjust the intensity of the light sources (12) and the shading position of the electric curtain (23) according to the conditions. Moreover, the intelligent illumination system can set a daytime illumination mode and nighttime illumination mode to build the most suitable situation for people's vision.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An intelligent illumination system comprising:
a three-dimensional space evenly divided into four main areas, and each two adjacent main areas having an overlapped area to form four adjacent areas; four ambient light sensors respectively installed in the four main areas, and four main area illumination values, which are respectively corresponding to the four main areas, measured by the ambient light sensors from a designed oblique angle; and
a controller electrically connected to the ambient light sensors to read the main area illumination values and to calculate each of adjacent area illumination values of adjacent areas, wherein the sum of the main area illumination values of each two adjacent main areas is configured to be averaged, then multiples by a direct illumination influence ratio, and adds an indirect illumination influence ratio so as to obtain each of the adjacent area illumination values of the adjacent areas.

2. The intelligent illumination system of claim 1, wherein a central area is formed at a center position of the main areas, and the adjacent area illumination values are configured to be averaged to obtain a central area illumination value.

3. The intelligent illumination system of claim 2, wherein a square-shaped floor plane of the three-dimensional space is evenly divided into the four square-shaped main areas, and the four ambient light sensors are respectively positioned at four corners of the three-dimensional space in the main areas.

4. The intelligent illumination system of claim 2, wherein a square-shaped floor plane of the three-dimensional space is evenly divided into the four triangle-shaped main areas, and the four ambient light sensors are respectively positioned in the main areas, and each of the four ambient light sensors is located at a position close to a middle of an edge of the three-dimensional space.

5. The intelligent illumination system of claim 2, wherein the direct illumination influence ratio is an attenuation ratio caused by the light range which is based on an average spacing among the light sources and a vertical height of light source.

6. The intelligent illumination system of claim 5, wherein the average spacing and the vertical height of light source form a hypotenuse distance as a triangle, and the direct illumination influence ratio is the reciprocal of the value of the hypotenuse distance, and the hypotenuse distance is obtained through the right-angled triangle definition.

7. The intelligent illumination system of claim 2, wherein the indirect illumination influence ratio is an average value of illumination accumulations from mutually reflecting between a ceiling and the floor in the three-dimensional space.

8. The intelligent illumination system of claim 7, wherein for obtaining the indirect illumination influence ratio, the sum of the main area illumination values is averaged, and multiples the reflected illumination which forms from the ceiling and the floor reflecting lights from the light sources, and the reflected illumination is calculated through the cumulative method to obtain corresponding reflected illumination values of materials in different environments, and each of the corresponding reflected illumination values is averaged to obtain that the ceiling has the fixed value of 0.65 and the floor has the fixed value of 0.15.

9. The intelligent illumination system of claim 2, wherein the controller is electrically connected to a projector, a screen, and at least an electric curtain, and the controller is adapted to automatically control the shading positions of the electric curtain based on the main area illumination values, the adjacent area illumination values, and the central area illumination value; when the projector and the screen are used, the controller is configured to automatically dim or turn off one or more of the light sources adjacent to the screen and control the electric curtain adjacent to the screen to perform full-shading synchronously.

10. The intelligent illumination system of claim 2, wherein the controller is electrically connected to a temperature sensor, a humidity sensor, and an optical sensor which are configured to respectively obtain the temperature of the three-dimensional space, the humidity of the three-dimensional space, and the outdoor sunlight illumination and direction, and the controller is electrically connected to at least an electric curtain and is adapted to automatically adjust the intensity of the light sources and the shading position of the electric curtain according to the environmental conditions.
